(19) United States
(12) Patent Application Publication
(10) Pub. No.: US 2026/0302627 A1
(43) Pub. Date: Oct. 1, 2026

(54) INTEGRATED ANTENNA STRUCTURE WITH LINEAR POLARIZATION EMISSION IN ARBITRARY POLARIZATION DIRECTION CAPABILITY

(71) Applicant: TMY Technology Inc., New Taipei City (TW)

(72) Inventor: Chun-Cheng Chan, New Taipei City (TW)

(73) Assignee: TMY Technology Inc., New Taipei City (TW)

(21) Appl. No.: 19/403,264

(22) Filed: Nov. 28, 2025

Related U.S. Application Data
(60) Provisional application No. 63/780,488, filed on Mar. 31, 2025.

(30) Foreign Application Priority Data
Oct. 7, 2025 (TW) 114138604

(51) Int. Cl. H01Q 9/04; H01Q 15/24

(52) U.S. Cl. CPC H01Q 9/0428; H01Q 9/0414; H01Q 15/24

(57) ABSTRACT

Provided is an integrated antenna structure with a linear polarization emission in an arbitrary polarization direction capacity. The integrated antenna structure includes a radiator, a first filter, a second filter and a 90-degree hybrid coupler. The radiator, the first filter and the 90-degree hybrid coupler are stacked in sequence. The radiator includes a first radiation patch unit and a second radiation patch unit. The first filter is coupling connected to the first radiation patch unit. The second filter is coupling connected to the second radiation patch unit. The 90-degree hybrid coupler is electrically connected to the first filter, and includes a first input end, a second input end, a first output end, and a second output end.

### CROSS-REFERENCE TO RELATED APPLICATION

This application claims the priority benefit of U.S. provisional application Ser. No. 63/780,488, filed on Mar. 31, 2025 and Taiwan application serial no. 114138604, filed on Oct. 7, 2025. The entirety of each of the above-mentioned patent applications is hereby incorporated by reference herein and made a part of this specification.

### BACKGROUND

### Technical Field

The disclosure relates to an antenna structure, and particularly relates to an integrated antenna structure with a linear polarization emission in an arbitrary polarization direction capability.

### Related Art

In conventional wireless communication systems, two different antenna arrays are needed to send and receive a signal. This sending and reception manner of the signal may bring problems, such as a large volume of the antenna arrays, high loss, high hardware costs, and a complex structure.

### SUMMARY

The disclosure provides an integrated antenna structure with a linear polarization emission in an arbitrary polarization direction capability, which can support sending and reception of a signal, and provide a linear polarization signal at an arbitrary angle.

Embodiments of the disclosure provide an integrated antenna structure with a linear polarization emission in an arbitrary polarization direction capability. The integrated antenna structure includes a radiator, a first filter, a second filter, and a 90-degree hybrid coupler. The radiator, the first filter, and the 90-degree hybrid coupler are stacked in sequence. The radiator includes a first radiation patch unit and a second radiation patch unit. The first filter is coupling connected to the first radiation patch unit. The second filter is coupling connected to the second radiation patch unit. The 90-degree hybrid coupler is electrically connected to the first filter. The 90-degree hybrid coupler includes a first input end, a second input end, a first output end and a second output end. In response to a first signal and a second signal being respectively fed to the first input end and the second input end, the radiator emits a linear polarization signal according to the first signal and the second signal.

In one embodiment of the disclosure, the first signal and the second signal have a same amplitude.

In one embodiment of the disclosure, an angle of the linear polarization signal is associated with a phase difference between the first signal and the second signal.

In one embodiment of the disclosure, in response to the first signal being fed to the first input end, the first radiation patch unit emits a left circular polarization signal according to the first signal. In response to the second signal being fed to the second input end, the first radiation patch unit emits a right circular polarization signal according to the second signal.

In one embodiment of the disclosure, the linear polarization signal is composed of the right circular polarization signal and the left circular polarization signal.

In one embodiment of the disclosure, in response to the first signal being fed to the first input end, the 90-degree hybrid coupler uniformly distributes the first signal into a first separated signal and a second separated signal. The 90-degree hybrid coupler outputs the first separated signal to the first filter through the first output end, and outputs the second separated signal to the first filter through the second output end. A phase difference between the first separated signal and the second separated signal is 90 degrees.

In one embodiment of the disclosure, the first filter performs filtering on the first separated signal and the second separated signal. The first radiation patch unit emits the left circular polarization signal according to a filtered first separated signal and a filtered second separated signal.

In one embodiment of the disclosure, in response to the second signal being fed to the second input end, the 90-degree hybrid coupler uniformly distributes the second signal into a third separated signal and a fourth separated signal. The 90-degree hybrid coupler outputs the third separated signal to the first filter through the first output end, and outputs the fourth separated signal to the first filter through the second output end. A phase difference between the third separated signal and the fourth separated signal is −90 degrees.

In one embodiment of the disclosure, the first filter performs filtering on the third separated signal and the fourth separated signal. The first radiation patch unit emits the right circular polarization signal according to a filtered third separated signal and a filtered fourth separated signal.

In one embodiment of the disclosure, the second radiation patch unit is disposed around the first radiation patch unit and is not directly connected to the first radiation patch unit. The first radiation patch unit has a plurality of irregular slots. The irregular slots are symmetrical to each other.

In one embodiment of the disclosure, the first filter further includes a first cross-shaped patch unit and a first square patch unit. The first cross-shaped patch unit includes a center slot, multiple U-shaped slots, a first feed end and a second feed end. The first square patch unit includes a slot. The first square patch unit is disposed between the radiator and the first cross-shaped patch unit. The first square patch unit is coupling connected to the first radiation patch unit.

In one embodiment of the disclosure, the first output end is connected to the first feed end through a first metal conductor. The second output end is connected to the second feed end through a second metal conductor.

In one embodiment of the disclosure, the second filter further includes a second rectangular patch unit and a second small patch unit. The second rectangular patch unit is connected to a receiving end. The second small patch unit is coupling connected to the second radiation patch unit.

In one embodiment of the disclosure, the second filter further includes a second large patch unit. The second large patch unit is disposed between the second rectangular patch unit and the second small patch unit. A size of the second large patch unit is not smaller than a size of the second rectangular patch unit.

In one embodiment of the disclosure, the first filter is a band-pass filter or a high-pass filter.

In one embodiment of the disclosure, the second filter is a band-stop filter or a low-pass filter.

In one embodiment of the disclosure, a passband of the first filter is between a first frequency band, and a passband of the second filter is between a second frequency band. The first frequency band does not overlap with the second frequency band.

Based on the above, the integrated antenna structure with the linear polarization emission in the arbitrary polarization direction capability provided by the embodiments of the disclosure may generate the left circular polarization signal based on a signal fed from the first feed end of the 90-degree hybrid coupler (that is, the first signal), and generate the right circular polarization signal based on a signal fed from the second feed end of the 90-degree hybrid coupler (that is, the second signal), and emit the linear polarization signal composed of the right circular polarization signal and the left circular polarization signal. The angle of the linear polarization signal is associated with the phase difference between the first signal and the second signal. Therefore, the integrated antenna structure provided by the embodiments of the disclosure can emit the linear polarization signal at the arbitrary angle based on the phase difference. In addition, an antenna structure configured to send a signal and an antenna structure configured to receive a signal among the integrated antenna structure provided by the embodiments of the disclosure share some elements (that is, the radiator), implementing high integration and reducing hardware costs.

### BRIEF DESCRIPTION OF THE DRAWINGS

FIG. 1 is a schematic view of an integrated antenna structure with a linear polarization emission in an arbitrary polarization direction capability according to an embodiment of the disclosure.

FIG. 2 is a side view and a bottom view of an integrated antenna structure with a linear polarization emission in an arbitrary polarization direction capability according to an embodiment of the disclosure.

FIG. 3 is a schematic view of a second filter according to an embodiment of the disclosure.

FIG. 4 is a conceptual block diagram of an integrated antenna structure with a linear polarization emission in an arbitrary polarization direction capability according to an embodiment of the disclosure.

FIG. 5 is a cross-sectional view of an integrated antenna structure with a linear polarization emission in an arbitrary polarization direction capability according to an embodiment of the disclosure.

FIG. 6 is a simulation graph of S parameters of a second filter according to an embodiment of the disclosure.

FIG. 7 is a simulation graph of S parameters of a stub according to an embodiment of the disclosure.

FIG. 8 is a simulation graph of S parameters of a stub according to an embodiment of the disclosure.

FIG. 9 is a simulation graph of S parameters of a second filter connected to a stub according to an embodiment of the disclosure.

FIG. 10 is a simulation graph of S parameters of an integrated antenna structure according to an embodiment of the disclosure.

FIG. 11 is a simulation graph of gains of an integrated antenna structure according to an embodiment of the disclosure.

### DESCRIPTION OF THE EMBODIMENTS

Some embodiments of the disclosure will be described in detail with reference to the accompanying drawings. The same reference numerals used in the following description and in different drawings will be regarded as referring to the same or similar elements.

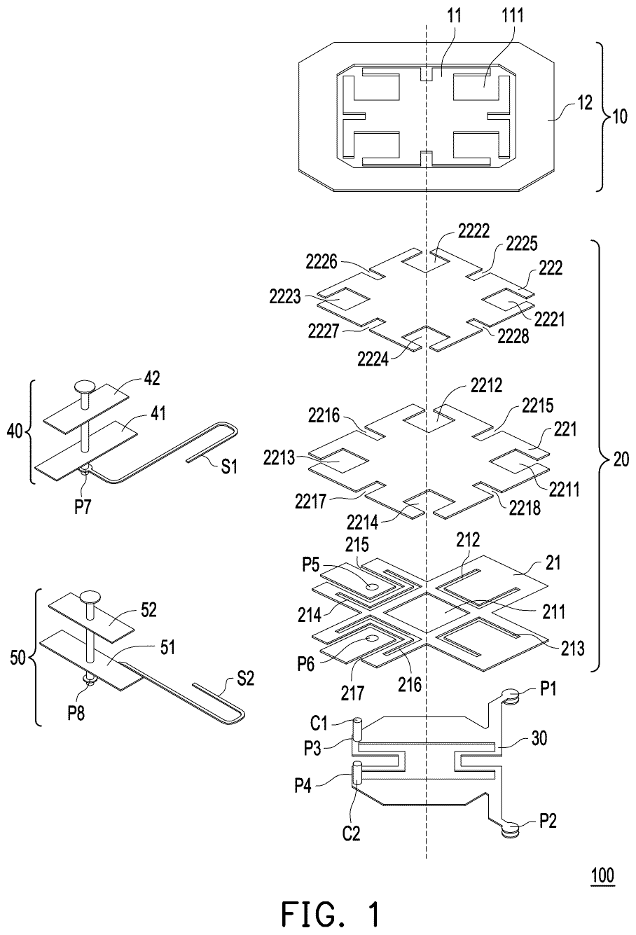

FIG. 1 is a schematic view of an integrated antenna structure with a linear polarization emission in an arbitrary polarization direction capability according to an embodiment of the disclosure. Please refer to FIG. 1. An integrated antenna structure 100 includes a radiator 10, a filter 20 (also referred to as a first filter), filters 40 and 50 (also referred to as a second filter), and a 90-degree hybrid coupler 30. In one embodiment, the filter 20 may be, for example, a band-pass filter or a high-pass filter. The filters 40 and 50 may respectively be, for example, a band-stop filter or a low-pass filter.

The radiator 10 includes a radiation patch unit 11 (also referred to as a first radiation patch unit) and a radiation patch unit 12 (also referred to as a second radiation patch unit). The filter 20 is coupling connected to the radiation patch unit 11. The filters 40 and 50 are coupling connected to the radiation patch unit 12. As shown in FIG. 1, the radiation patch unit 12 is disposed around the radiation patch unit 11. The radiation patch unit 11 has multiple irregular slots 111. The irregular slots 111 are symmetrical to each other. It should be noted that the radiation patch unit 12 is not directly connected to the radiation patch unit 11. As shown in the structure of FIG. 1, there is a gap between the two. Further, the symmetrical irregular slots 111 are not limited to the shape shown in FIG. 1. A designer may custom design according to actual needs (such as a coupling rate needed), and the disclosure is not limited thereto. In one embodiment, the radiation patch units 11 and 12 may be, for example, metal patches printed on a double-sided high-frequency printed circuit board.

The filter 20 includes a cross-shaped patch unit 21 (also referred to as a first cross-shaped patch unit) and square patch units 221 and 222 (also referred to as first square patch units). As shown in FIG. 1, the cross-shaped patch unit 21 includes a center slot 211 and U-shaped slots 212 to 217. The square patch unit 221 and the square patch unit 222 respectively include slots 2211 to 2218 and slots 2221 to 2228. It should be noted that a quantity of the square patch units 221 and 222 may be custom designed according to actual needs, and the disclosure is not limited thereto. In one embodiment, the cross-shaped patch unit 21 and the square patch units 221 and 222 may be, for example, metal patches located on an inner layer of a multilayer double-sided high-frequency printed circuit board.

It is worth mentioning that, as shown in FIG. 1, a shape of the square patch unit 221 is the same as a shape and a size of the radiation patch unit 11. The shape of the square patch unit 221 is the same as a shape of the square patch unit 222. A size of the square patch unit 221 is slightly larger than a size of the square patch unit 222. The square patch units 221 and 222 are rotated 45 degrees relative to the radiation patch unit 11. Specifically, the shapes and sizes of the radiation patch unit 11, the square patch unit 221, and the square patch unit 222 may be different. A distance and/or a relative angle between the radiation patch unit 11, the square patch unit 221, and the square patch unit 222 may also be adjusted to control a coupling rate. In addition, a quantity of the square patch units 221 and 222 in FIG. 1 is two. Regarding a quantity of square patch units, it may also be one or two and above, and the disclosure is not limited thereto. Further, if the quantity of the square patch units is greater, a filtering effect of the first filter 20 is better, but an attenuation level also correspondingly increases. In addition, if an angle difference between multiple square patch units is greater, a coupling effect between the multiple square patch units is worse, and an attenuation level also increases.

That is, the integrated antenna structure 100 shown in FIG. 1 is one aspect of the disclosure. The designer may custom design the integrated antenna structure 100 according to actual needs, and the disclosure is not limited thereto. For example, a relative angle between the radiation patch unit 11 and the square patch units 221 and 222 may be 0 degrees. For example, the square patch units 221 and 222 may also have no slots.

The cross-shaped patch unit 21 has a feed end P5 (also referred to as a first feed end) and a feed end P6 (also referred to as a second feed end). Specifically, the cross-shaped patch unit 21 may be, for example, a feed portion of the filter 20. The cross-shaped patch unit 21 may, for example, receive a signal from the 90-degree hybrid coupler 30 through the feed ends P5 and P6. It should be noted that the center slot 211 and the U-shaped slots 212 to 217 on the cross-shaped patch unit 21 are configured to allow the signal fed from the feed ends P5 and P6 to be uniformly distributed on the cross-shaped patch unit 21. Regarding a shape of the cross-shaped patch unit 21 and a type and a quantity of the slots included, the designer may custom design according to actual needs, and the disclosure is not limited thereto. For example, the cross-shaped patch unit 21 may also include the center slot 211 without including the U-shaped slots 212 to 217.

The square patch units 221 and 222 are disposed between the radiator 10 and the cross-shaped patch unit 21. Specifically, the square patch units 221 and 222 may be, for example, a filtering portion of the filter 20. The square patch units 221 and 222 may, for example, perform filtering on a signal fed from the feed ends P5 and P6. The square patch units 221 and 222 may, for example, be coupling connected to the radiation patch unit 11, so that the radiation patch unit 11 may emit a linear polarization signal or a circular polarization signal according to a filtered signal.

The 90-degree hybrid coupler 30 includes an input end P1 (also referred to as a first input end), an input end P2 (also referred to as a second input end), an output end P3 (also referred to as a first output end), and an output end P4 (also referred to as a second output end). The 90-degree hybrid coupler 30 is electrically connected to the filter 20. Specifically, the output end P3 is connected to the feed end P5 through a metal conductor C1 (also referred to as a first metal conductor). The output end P4 is connected to the feed end P6 through a metal conductor C2 (also referred to as a second metal conductor). The metal conductors C1 and C2 may be, for example, copper pillars.

The radiator 10, the filter 20, and the 90-degree hybrid coupler 30 are stacked in sequence. As shown in FIG. 1, center points of the radiation patch unit 11, the cross-shaped patch unit 21, the square patch unit 221, the square patch unit 222, and the 90-degree hybrid coupler 30 are aligned.

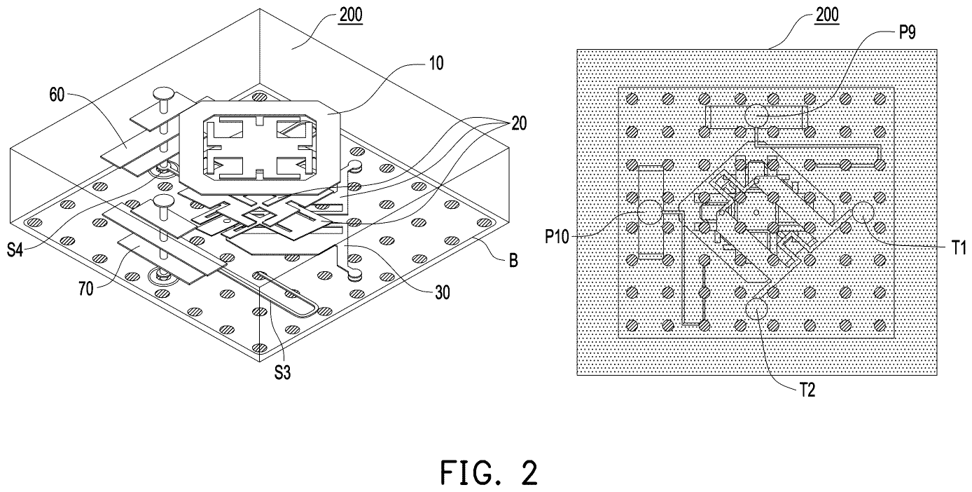

The filters 40 and 50 respectively include rectangular patch units 41 and 51 (also referred to as second rectangular patch units) and small patch units 42 and 52 (also referred to as second small patch units). The rectangular patch units 41 and 51 respectively have receiving ends P7 and P8. Specifically, the small patch units 42 and 52 may be respectively, for example, a filtering portion of the filters 40 and 50. The rectangular patch units 41 and 51 may be respectively, for example, a feed portion of the filters 40 and 50. The small patch units 42 and 52 may be, for example, coupling connected to the radiation patch unit 12. A signal may be, for example, fed from the radiation patch unit 12 to the small patch units 42 and 52. The small patch units 42 and 52 and the rectangular patch units 41 and 51 may perform impedance matching and filtering on the signal. The rectangular patch units 41 and 51 may transmit a filtered signal to the receiving ends P7 and P8. In one embodiment, the rectangular patch units 41 and 51 and the small patch units 42 and 52 may be, for example, metal patches located on an inner layer of a multilayer double-sided high-frequency printed circuit board. The receiving ends P7 and P8 are respectively connected to stubs S1 and S2 whose main function is impedance matching. FIG. 2 is a side view and a bottom view of an integrated antenna structure with a linear polarization emission in an arbitrary polarization direction capability according to an embodiment of the disclosure. Please refer to FIG. 1 and FIG. 2 at the same time. An integrated antenna structure 200 is disposed on a substrate B. In the embodiment, in addition to the radiator 10, the filter 20, and the 90-degree hybrid coupler 30 as shown in FIG. 1, the integrated antenna structure 200 further includes filters 60 and 70 (also referred to as second filters). The integrated antenna structure 200 includes sending ends T1 and T2 (that is, the input ends P1 and P2 in FIG. 1) and receiving ends P9 and P10. The receiving ends P9 and P10 of the filters 60 and 70 are respectively connected to stubs S4 and S3 whose main function is impedance matching.

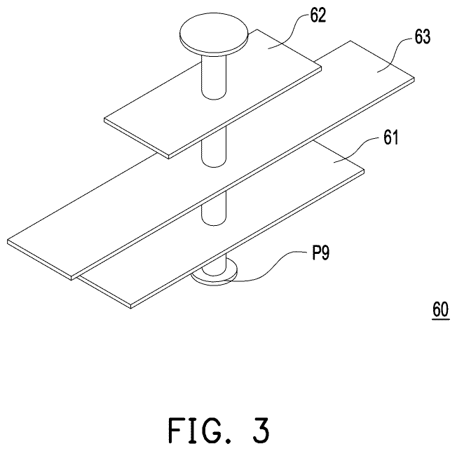

The filters 60 and 70 may be as shown in FIG. 3. FIG. 3 is a schematic view of a second filter according to an embodiment of the disclosure. Please refer to FIG. 1 to FIG. 3 at the same time. The filter 60 and the filter 70 are the same elements. Taking the filter 60 as an example, the filter 60 includes a rectangular patch unit 61, a small patch unit 62, a large patch unit 63, and the receiving end P9. The rectangular patch unit 61, the small patch unit 62, and the receiving end P9 are similar elements to the rectangular patch units 41 and 51, the small patch units 42 and 52, and the receiving ends P7 and P8. In addition, when a size of the large patch unit 63 is greater than or equal to a size of the rectangular patch unit 61, the filter 60 has a better filtering effect. In one embodiment, the rectangular patch unit 61, the small patch unit 62, and the large patch unit 63 may be, for example, metal patches located on an inner layer of a multilayer double-sided high-frequency printed circuit board.

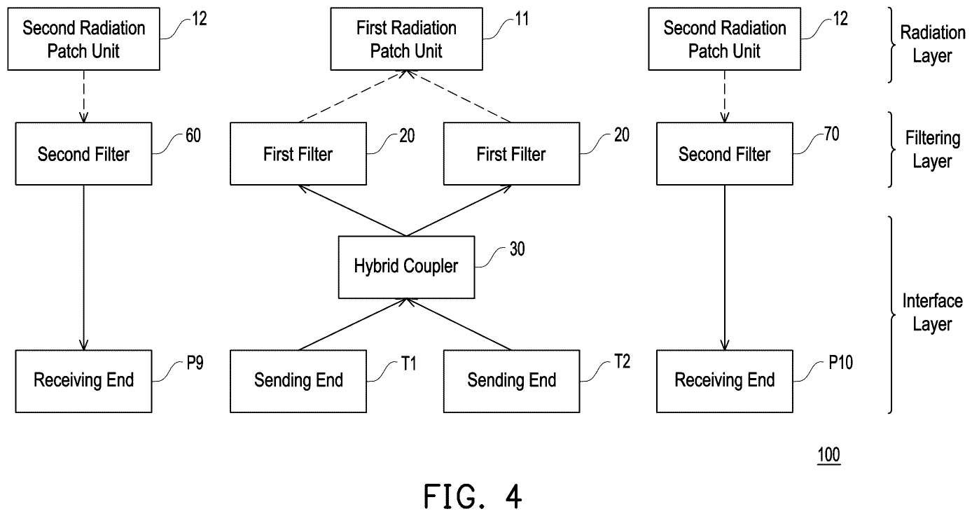

FIG. 4 is a conceptual block diagram of an integrated antenna structure with a linear polarization emission in an arbitrary polarization direction capability according to an embodiment of the disclosure. Please refer to FIG. 1, FIG. 2, and FIG. 4 at the same time. The integrated antenna structure 200 may be divided into a radiation layer, a filtering layer, and an interface layer. The radiation layer includes a first radiation patch unit 11 and a second radiation patch unit 12. The filtering layer includes the first filter 20 and the second filters 60 and 70. The interface layer includes the hybrid coupler 30, the sending ends T1 and T2, and the receiving ends P9 and P10.

The integrated antenna structure 200 supports sending and reception of a signal. That is, the integrated antenna structure 200 is a duplex antenna array structure, which has a two-portion antenna structure configured to send a signal and configured to receive a signal. The two-portion antenna structure share the radiator 10 (that is, the first radiation patch unit 11 and the second radiation patch unit 12) to send a signal and receive a signal, so as to decrease hardware costs. In addition, the two-portion antenna structure has high integration and high isolation. Specifically, the first radiation patch unit 11, the first filter 20, the 90-degree hybrid coupler 30, and the sending ends T1 and T2 may constitute a sending portion of the integrated antenna structure 200 (that is, a portion of the antenna structure configured to send a signal). In addition, the second radiation patch unit 12, the second filters 60 and 70, and the receiving ends P9 and P10 may constitute a receiving portion of the integrated antenna structure 200 (that is, a portion of the antenna structure configured to receive a signal). Further, the filter 20 may be, for example, a band-pass filter or a high-pass filter. The filters 40 and 50 may be, for example, a band-stop filter or a low-pass filter. A passband of the filter 20 is between a first frequency band. A passband of the filters 40 and 50 is between a second frequency band. The first frequency band does not overlap with the second frequency band. Therefore, the sending portion and the receiving portion of the integrated antenna structure 200 do not interfere with each other.

On the other hand, please refer to FIG. 1 again. The integrated antenna structures 100 and 200 may further be configured to emit a circular polarization signal or a linear polarization signal.

When two signals with a same amplitude are respectively fed to the input end P1 and the input end P2, the radiator 10 may emit a linear polarization signal according to the two signals.

Specifically, when a signal (also referred to as a first signal) is fed to the input end P1, the radiation patch unit 11 may emit a left circular polarization signal according to the first signal. When another signal (also referred to as a second signal) is fed to the input end P2, the radiation patch unit 11 may emit a right circular polarization signal according to the second signal. The right circular polarization signal and the left circular polarization signal may be combined into the foregoing linear polarization signal.

Further, when the first signal is fed to the input end P1, the 90-degree hybrid coupler 30 uniformly distributes the first signal into two separated signals with a same energy and a phase difference of 90 degrees (respectively referred to as a first separated signal and a second separated signal). Subsequently, the 90-degree hybrid coupler 30 respectively outputs the two separated signals to the filter 20 through the output end P3 and the output end P4. Specifically, the 90-degree hybrid coupler 30 may, for example, output the first separated signal to the filter 20 through the output end P3, and output the second separated signal to the filter 20 through the output end P4. A phase of the second separated signal output from the output end P4 lags behind a phase of the first separated signal output from the output end P3 by 90 degrees. Accordingly, the filter 20 may receive the first separated signal through the feed end P5, and receive the second separated signal through the feed end P6.

The filter 20 performs filtering on the first separated signal and the second separated signal to inhibit energy outside a desired frequency band (also referred to as noise), and couples a filtered first separated signal and a filtered second separated signal to the radiation patch unit 11. Accordingly, the radiation patch unit 11 may emit a left circular polarization signal according to the filtered first separated signal and the filtered second separated signal.

On the other hand, when the second signal is fed to the input end P2, the 90-degree hybrid coupler 30 uniformly distributes the second signal into two separated signals with a same energy and a phase difference of −90 degrees (respectively referred to as a third separated signal and a fourth separated signal). Subsequently, the 90-degree hybrid coupler 30 respectively outputs the two separated signals to the filter 20 through the output end P3 and the output end P4. Specifically, the 90-degree hybrid coupler 30 may, for example, output the third separated signal to the filter 20 through the output end P3, and output the fourth separated signal to the filter 20 through the output end P4. A phase of the third separated signal output from the output end P3 lags behind a phase of the fourth separated signal output from the output end P4 by 90 degrees. Accordingly, the filter 20 may receive the third separated signal through the feed end P5, and receive the fourth separated signal through the feed end P6.

The filter 20 performs filtering on the third separated signal and the fourth separated signal to inhibit noise, and couples a filtered third separated signal and a filtered fourth separated signal to the radiation patch unit 11. Accordingly, the radiation patch unit 11 may emit a right circular polarization signal according to the filtered third separated signal and the filtered fourth separated signal.

Finally, when the first signal and the second signal with a same amplitude are respectively fed to the input end P1 and the input end P2, the radiation patch unit 11 may respectively generate a left circular polarization signal and a right circular polarization signal according to the first signal and the second signal, and emit a linear polarization signal generated by the right circular polarization signal and the left circular polarization signal. In one embodiment, an angle of the foregoing linear polarization signal is associated with a phase difference between the first signal and the second signal. The radiator 10 may convert the first signal and the second signal into a dual circular polarization signal, and combine the dual circular polarization signal into the linear polarization signal at an arbitrary angle (2 degrees/step).

To further illustrate, assume that a vertical component and a horizontal component of an electromagnetic wave signal are respectively \hat{V} and Ĥ. If the electromagnetic wave signal is a right-handed signal, an electric field when propagating in a z-axis direction may be expressed as:

$$E ( z , t ) = {E}_{0} cos ( ω t - kz ) \hat{H} + {E}_{0} sin ( ω t - kz ) \hat{V}$$

Alternatively, the electric field may be expressed as:

$$E ( z , t ) = {E}_{0} cos ( ω t - kz ) \hat{H} + {E}_{0} cos ( ω t - kz - \frac{π}{2} ) \hat{V}$$

Conversely, if the electromagnetic wave signal is a left-handed signal, an electric field when propagating in the z-axis direction may be expressed as:

$$E ( z , t ) = {E}_{0} cos ( ω t - kz ) \hat{H} - {E}_{0} sin ( ω t - kz ) \hat{V}$$

Alternatively, the electric field may be expressed as:

$$E ( z , t ) = {E}_{0} cos ( ω t - kz ) \hat{H} + {E}_{0} cos ( ω t - kz + \frac{π}{2} ) \hat{V}$$

In the foregoing mathematical expressions, E₀ is the complex constant amplitude vector, ω is the angular frequency, t is the time, and k is the wave vector.

When a phase difference between the first signal and the second signal is θ degrees (that is, a phase of the first signal leads a phase of the second signal by θ degrees), an electric field of a left circular polarization signal and a right circular polarization signal when propagating in the z-axis direction may be expressed as follows:

The electric field of the left circular polarization signal when propagating in the z-axis direction may be expressed as:

$$E ( z , t ) = {E}_{0} cos ( ω t - kz - \frac{π}{2} + θ ) \hat{H} + {E}_{0} cos ( ω t - kz + θ ) \hat{V}$$

The electric field of the right circular polarization signal when propagating in the z-axis direction may be expressed as:

$$E ( z , t ) = {E}_{0} cos ( ω t - kz ) \hat{H} + {E}_{0} cos ( ω t - kz - \frac{π}{2} ) \hat{V}$$

An electric field of a superimposed signal of the left circular polarization signal and the right circular polarization signal (that is, a linear polarization signal) when propagating in the z-axis direction may be expressed as:

$$E ( z , t ) = 2 {E}_{0} cos ( ω t - kz - \frac{π}{4} + \frac{θ}{2} ) cos ( - \frac{π}{4} + \frac{θ}{2} ) \hat{H} + 2 {E}_{0} cos ( ω t - kz - \frac{π}{2} + \frac{θ}{2} ) sin ( - \frac{π}{2} + \frac{θ}{2} ) \hat{H}$$

Accordingly, when the phase of the first signal leads the phase of the second signal by θ degrees, a polarization direction of a superimposed signal (that is, a signal emitted by the radiation patch unit 11) is

$$- \frac{π}{2} + \frac{θ}{2} .$$

The integrated antenna structures 100 and 200 may emit a linear polarization signal at an arbitrary angle based on a phase difference between two signals (that is, the first signal and the second signal) fed to the different input ends P1 and P2 of the 90-degree hybrid coupler 30.

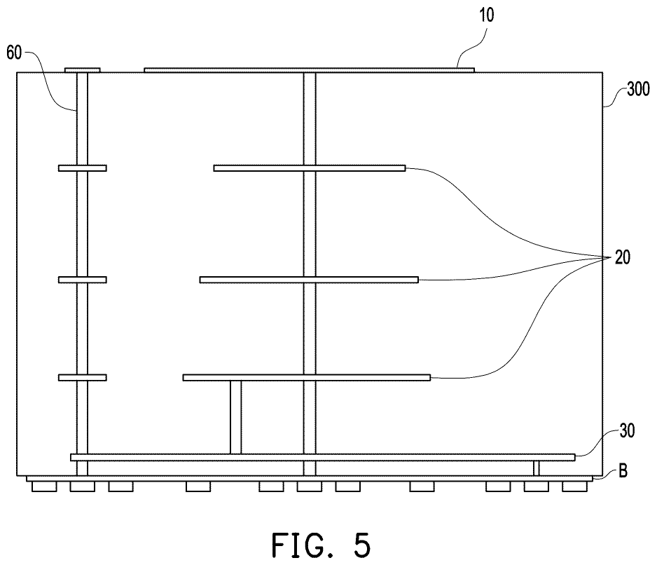

FIG. 5 is a cross-sectional view of an integrated antenna structure with a linear polarization emission in an arbitrary polarization direction capability according to an embodiment of the disclosure. Please refer to FIG. 5. An integrated antenna structure 300 is disposed on the substrate B. The integrated antenna structure 300 includes the radiator 10 as shown in FIG. 1, the first filter 20, the 90-degree hybrid coupler 30, and the second filter 60 as shown in FIG. 2. As shown in FIG. 5, it may be known that there are gaps between the radiator 10, the first filter 20, and the 90-degree hybrid coupler 30, which are not completely bonded. There are also gaps between each patch unit between the first filter 20 (or the second filter 60).

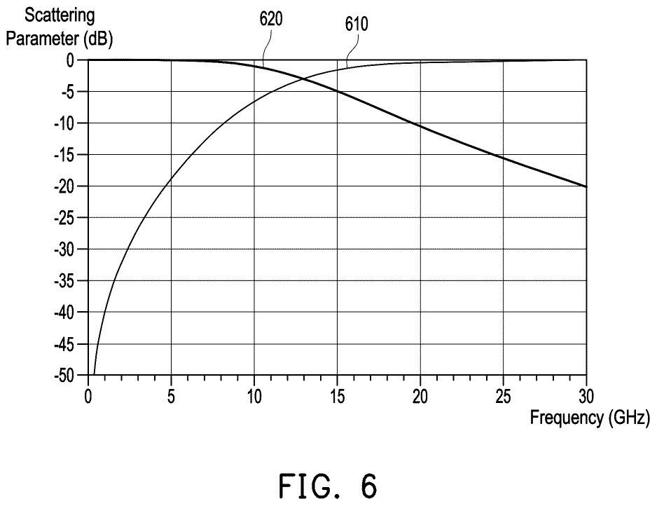

FIG. 6 is a simulation graph of S parameters of a second filter (such as the filters 40 and 50 shown in FIG. 1) according to an embodiment of the disclosure. Please refer to FIG. 1 and FIG. 6 at the same time. In the embodiment, the filters 40 and 50 are low-pass filters. An impedance of the small patch units 42 and 52 is 50 ohms. The rectangular patch units 41 and 51 may be regarded as an equivalent capacitance of 0.5 picofarads (pF). Curve 610 represents an S11 parameter (that is, an input reflection coefficient or a return loss of the receiving ends P7 and P8). Curve 620 represents an S12 parameter (that is, a reverse transmission coefficient or an isolation from the small patch units 42 and 52 to the receiving ends P7 and P8).

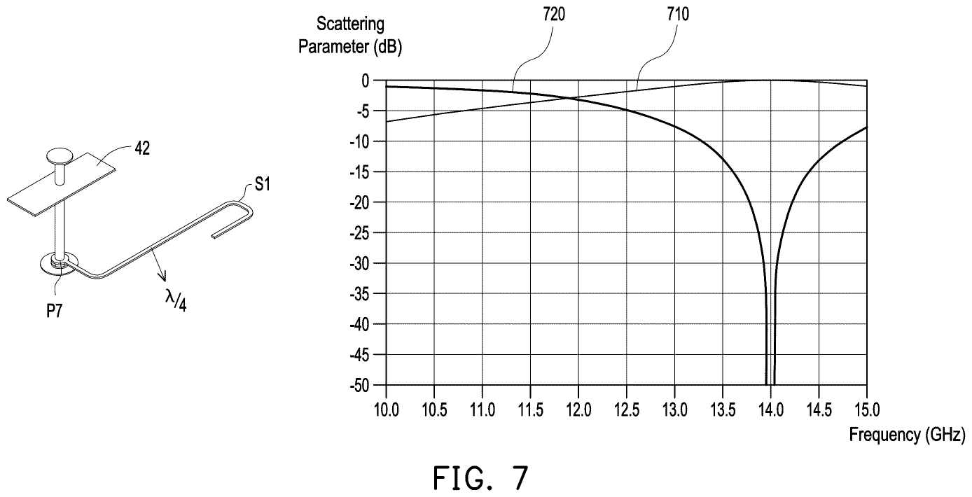

FIG. 7 is a simulation graph of S parameters of a stub (such as the stub S1) according to an embodiment of the disclosure. Please refer to FIG. 1 and FIG. 7 at the same time. In the embodiment, an electrical length of the stub S1 is, for example, λ/4. λ is the wavelength corresponding to a center operating frequency of the integrated antenna structure 100. That is, a signal having the operating frequency experiences a quarter wavelength when passing through the stub S1. The S parameters of the stub S1 are simulated with elements shown in the left half of FIG. 7. An impedance of the small patch unit 42 is 50 ohms, an impedance of the stub S1 is 100 ohms, and a stopband of the filter 40 is 14 gigahertz (GHz). Curve 710 represents an S11 parameter (that is, an input reflection coefficient or a return loss of the stub S1). Curve 720 represents an S12 parameter (that is, a reverse transmission coefficient or an isolation of the stub S1).

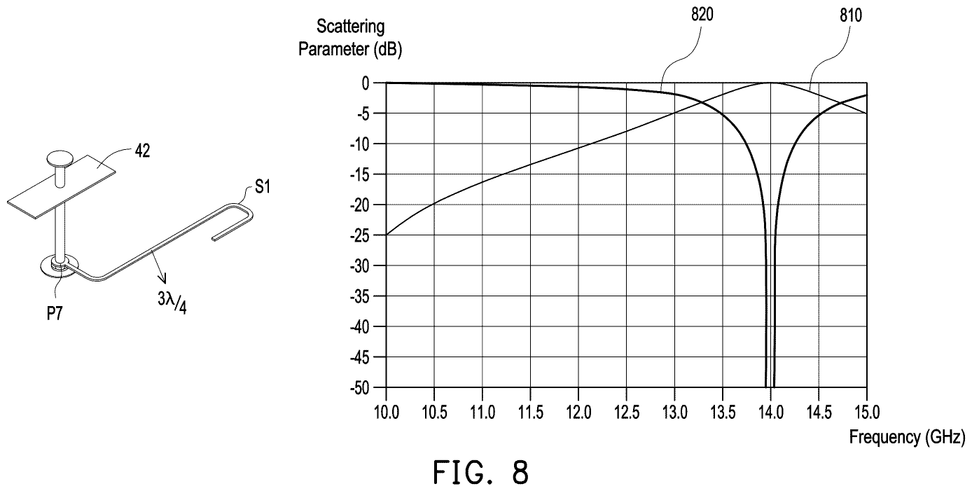

FIG. 8 is a simulation graph of S parameters of a stub (such as the stub S1) according to an embodiment of the disclosure. Please refer to FIG. 1 and FIG. 8 at the same time. In the embodiment, an electrical length of the stub S1 is, for example, 3λ/4. The S parameters of the stub S1 are simulated with elements shown in the left half of FIG. 8. An impedance of the small patch unit 42 is 50 ohms, an impedance of the stub S1 is 100 ohms, and a stopband of the filter 40 is 14 gigahertz. Curve 810 represents an S11 parameter. Curve 820 represents an S12 parameter.

A main function of the stubs S1 and S2 is impedance matching to avoid signal distortion and enhance a signal-to-noise ratio. In one embodiment, an electrical length of the stubs S1 and S2 is, for example, (2n+1)λ/4. n is any positive integer. A performance of the stubs S1 and S2 is positively correlated with a value of n. According to FIG. 7 and FIG. 8, it may be known that a return loss of the stub S1 with an electrical length of 3λ/4 is less than a return loss of the stub S1 with an electrical length of λ/4. That is, a performance of the stub S1 with the electrical length of 3λ/4 is superior to a performance of the stub S1 with the electrical length of λ/4.

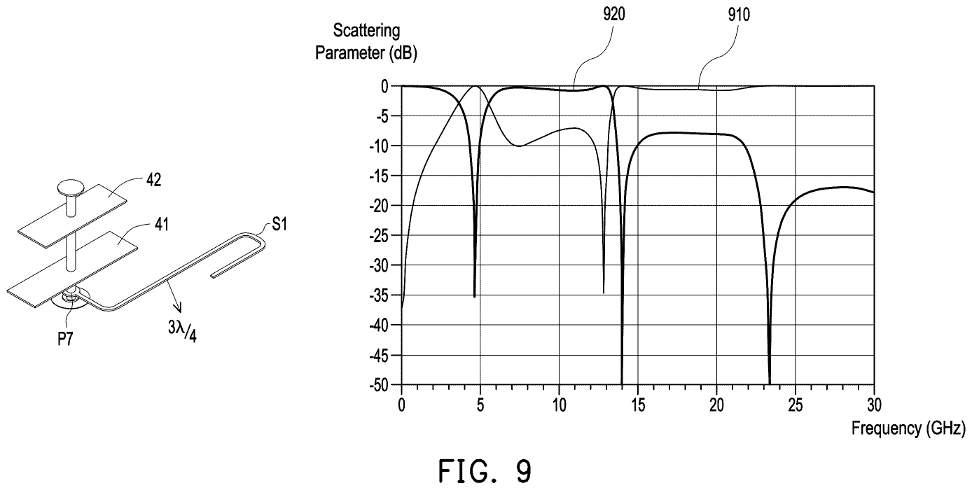

FIG. 9 is a simulation graph of S parameters of a second filter (such as the filter 40 shown in FIG. 1) connected to a stub (such as the stub S1) according to an embodiment of the disclosure. Please refer to FIG. 1 and FIG. 9 at the same time. In the embodiment, an electrical length of the stub S1 is, for example, 3λ/4. The S parameters of the stub S1 are simulated with elements shown in the left half of FIG. 9. An impedance of the small patch unit 42 is 50 ohms, the rectangular patch unit 41 may be regarded as an equivalent capacitance of 0.5 picofarads, an impedance of the stub S1 is 70 ohms, and a stopband of the filter 40 is 14 gigahertz. Curve 910 represents an S11 parameter (that is, an input reflection coefficient or a return loss of the receiving end P7). Curve 920 represents an S12 parameter (that is, a reverse transmission coefficient or an isolation from the small patch unit 42 to the receiving end P7).

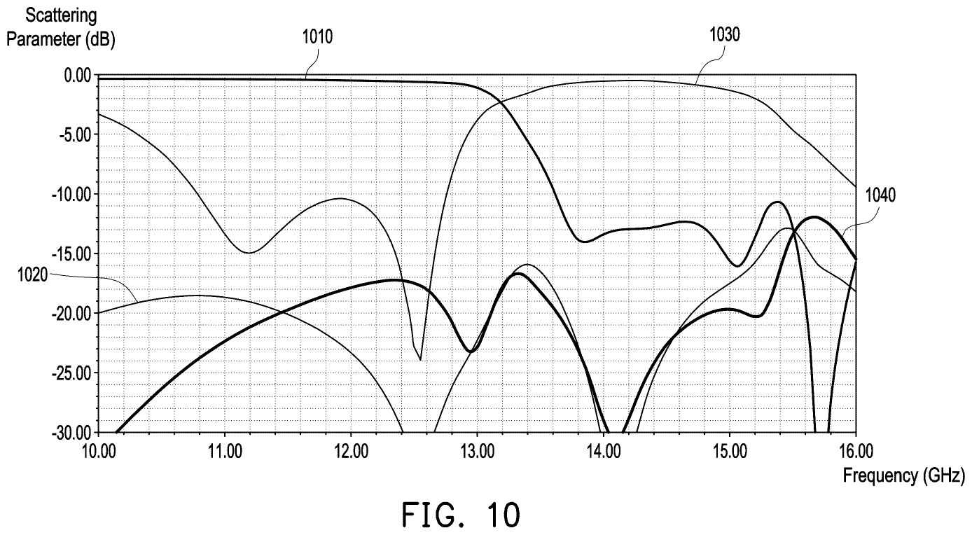

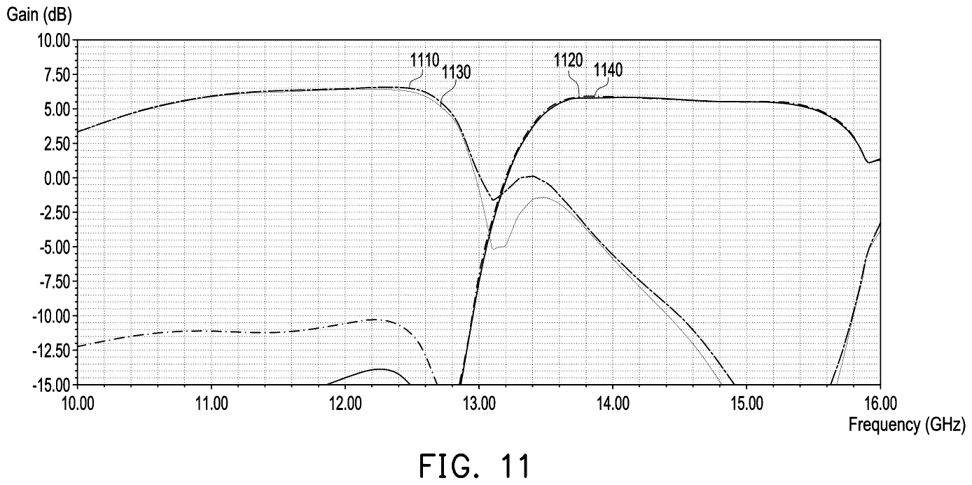

FIG. 10 is a simulation graph of S parameters of an integrated antenna structure according to an embodiment of the disclosure. FIG. 11 is a simulation graph of gains of an integrated antenna structure according to an embodiment of the disclosure. Please refer to FIG. 2, FIG. 10, and FIG. 11 at the same time. In the embodiment, the filter 20 is a high-pass filter with a passband ranging from 13.75 GHz to 15.80 GHz. In addition, the filters 60 and 70 are low-pass filters with a passband ranging from 10 GHz to 12.90 GHz. Curve 1010 represents an S11 parameter of a sending portion of the integrated antenna structure 200. Curve 1020 represents an S11 parameter of a receiving portion of the integrated antenna structure 200. Curve 1030 represents an S12 parameter of the sending portion of the integrated antenna structure 200. Curve 1040 represents an S12 parameter of the receiving portion of the integrated antenna structure 200. In addition, curves 1110 and 1130 in FIG. 11 represent gains of the receiving portion of the integrated antenna structure 200. Curves 1120 and 1140 in FIG. 11 represent gains of the sending portion of the integrated antenna structure 200.

In summary, the integrated antenna structure with the linear polarization emission in the arbitrary polarization direction capability provided by the embodiments of the disclosure is a duplex antenna structure having high integration and high isolation, which can emit the linear polarization signal at an arbitrary angle based on a phase difference between two signals (that is, the first signal and the second signal) fed to the different input ends of the 90-degree hybrid coupler.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An integrated antenna structure with a linear polarization emission in an arbitrary polarization direction capability, comprising:
a radiator, comprising a first radiation patch unit and a second radiation patch unit;
a first filter, coupling connected to the first radiation patch unit;
a second filter, coupling connected to the second radiation patch unit; and
a 90-degree hybrid coupler, electrically connected to the first filter, comprising a first input end, a second input end, a first output end and a second output end,
wherein the radiator, the first filter and the 90-degree hybrid coupler are stacked in sequence,
wherein, in response to a first signal and a second signal being respectively fed to the first input end and the second input end, the radiator emits a linear polarization signal according to the first signal and the second signal.

2. The integrated antenna structure according to claim 1, wherein the first signal and the second signal have a same amplitude.

3. The integrated antenna structure according to claim 1, wherein an angle of the linear polarization signal is associated with a phase difference between the first signal and the second signal.

4. The integrated antenna structure according to claim 1, wherein
in response to the first signal being fed to the first input end, the first radiation patch unit emits a left circular polarization signal according to the first signal, and
in response to the second signal being fed to the second input end, the first radiation patch unit emits a right circular polarization signal according to the second signal.

5. The integrated antenna structure according to claim 4, wherein the linear polarization signal is composed of the right circular polarization signal and the left circular polarization signal.

6. The integrated antenna structure according to claim 4, wherein
in response to the first signal being fed to the first input end, the 90-degree hybrid coupler uniformly distributes the first signal into a first separated signal and a second separated signal, and
the 90-degree hybrid coupler outputs the first separated signal to the first filter through the first output end, and outputs the second separated signal to the first filter through the second output end,
wherein a phase difference between the first separated signal and the second separated signal is 90 degrees.

7. The integrated antenna structure according to claim 6, wherein
the first filter performs filtering on the first separated signal and the second separated signal, and
the first radiation patch unit emits the left circular polarization signal according to a filtered first separated signal and a filtered second separated signal.

8. The integrated antenna structure according to claim 4, wherein
in response to the second signal being fed to the second input end, the 90-degree hybrid coupler uniformly distributes the second signal into a third separated signal and a fourth separated signal, and
the 90-degree hybrid coupler outputs the third separated signal to the first filter through the first output end, and outputs the fourth separated signal to the first filter through the second output end,
wherein a phase difference between the third separated signal and the fourth separated signal is −90 degrees.

9. The integrated antenna structure according to claim 8, wherein
the first filter performs filtering on the third separated signal and the fourth separated signal, and
the first radiation patch unit emits the right circular polarization signal according to a filtered third separated signal and a filtered fourth separated signal.

10. The integrated antenna structure according to claim 1,
wherein the second radiation patch unit is disposed around the first radiation patch unit and is not directly connected to the first radiation patch unit,
wherein the first radiation patch unit has a plurality of irregular slots, and the irregular slots are symmetrical to each other.

11. The integrated antenna structure according to claim 1, wherein the first filter further comprises:
a first cross-shaped patch unit, comprising a center slot, a plurality of U-shaped slots, a first feed end and a second feed end; and
a first square patch unit, comprising a slot, disposed between the radiator and the first cross-shaped patch unit, and coupling connected to the first radiation patch unit.

12. The integrated antenna structure according to claim 11, wherein the first output end is connected to the first feed end through a first metal conductor, and the second output end is connected to the second feed end through a second metal conductor.

13. The integrated antenna structure according to claim 1, wherein the second filter further comprises:
a second rectangular patch unit, connected to a receiving end; and
a second small patch unit, coupling connected to the second radiation patch unit.

14. The integrated antenna structure according to claim 13, wherein the second filter further comprises:
a second large patch unit, disposed between the second rectangular patch unit and the second small patch unit,
wherein a size of the second large patch unit is not smaller than a size of the second rectangular patch unit.

15. The integrated antenna structure according to claim 1, wherein the first filter is a band-pass filter or a high-pass filter.

16. The integrated antenna structure according to claim 1, wherein the second filter is a band-stop filter or a low-pass filter.

17. The integrated antenna structure according to claim 1, wherein a passband of the first filter is between a first frequency band, a passband of the second filter is between a second frequency band, wherein the first frequency band does not overlap with the second frequency band.
